(19) United States
(12) Patent Application Publication
(10) Pub. No.: US 2015/0051722 A1
(43) Pub. Date: Feb. 19, 2015

(54) METHOD, APPARATUS AND SYSTEM FOR PROVIDING CONTENT

(71) Applicant: FUSENET INC., Burlington (CA)

(72) Inventors: Sanjay Singhal, Burlington (CA); Ryan Van Barneveld, Burlington (CA); David Tait, Burlington (CA)

(73) Assignee: FUSENET INC., Burlington (CA)

(21) Appl. No.: 13/967,990

(22) Filed: Aug. 15, 2013

(51) Int. Cl. G06F 3/16

(52) U.S. Cl. CPC G06F 3/165
USPC 700/94

(57) ABSTRACT

A portable electronic device, methods of controlling the portable electronic device and computer readable medium are provided. The portable electronic device includes a network interface, a memory storage unit and a processor for carrying out a method. A method involves generating audio output, receiving an input corresponding to a sleep detection request, detecting another input associated with a sleep detection process, and terminating generation of the audio output. Another method involves loading a pointer value stored in the memory storage unit, loading the audiobook associated with the pointer, setting a second time-position of the audiobook associated with the pointer value, and generating audio output. The computer readable medium directs a processor to carry out a method.

### FIELD

The present specification relates generally to providing content, and more particularly to a providing content from a portable electronic device.

### BACKGROUND

In general, users use a sleep timer to conserve power and other resources to turn a device off when a user anticipates that they will no longer use a device (eg. the user falls asleep). Traditionally, a standard sleep timer for a device that provides content is set with a predetermined sleep duration based on the setting of a countdown timer. Once the countdown timer is set, the countdown timer is started and the timer begins to decrease. When the countdown timer reaches zero, the device shuts down. In general, the user cannot accurately predict when sleep will occur when setting the sleep timer. Accordingly, this often results in a waste of power and other resources as the device may continue to provide content after the user has fallen asleep.

In addition, some devices that provide content and can also provide a bookmark to mark a location of the content for playback later. Traditionally, the device would subsequently resume providing content from that specific location at a later time. However, the user often forgets the content immediately before the bookmark. This results in excess searching of the content by the user further users power and resources.

### SUMMARY

In accordance with an aspect of the specification, there is provided an electronic device. The electronic device includes a network interface for connecting the electronic device to a network. The electronic device further includes a memory storage unit for storing data corresponding to an audiobook. Furthermore, the electronic device includes a processor in electrical communication with the network interface and the memory storage unit. The processor is configured to generate audio output corresponding to the audiobook. Furthermore, the processor is configured to receive a first input corresponding to a sleep detection request. In addition, the processor is configured to detect a second input associated with a sleep detection process. The processor is further configured to terminate generation of the audio output when the second input fails to be detected.

The processor may be further configured to carry out a passive sleep detection process. The passive sleep detection process may involve continuously receiving the second input.

The processor may be further configured to carry out an active sleep detection process. The active sleep detection process may involve discretely receiving the second input periodically.

The processor may be further configured to store a value in a pointer associated with a first time-position of the audiobook.

The processor may be further configured to update the pointer associated with the first time-position of the audiobook.

The processor may be further configured to resume the generation of the audio output from a second time-position based on the pointer.

The second time-position may be set to be equal to the first time-position.

The second time-position may be set to be a predetermined period of time before the first time-position.

The predetermined period of time may be calculated based on an elapsed time since terminating the generation of the audio output.

In accordance with an aspect of the specification, there is provided a method of controlling an electronic device. The method involves generating audio output at a processor. The audio output corresponds to an audiobook. The method further involves receiving, at the processor, a first input corresponding to a sleep detection request. In addition, the method involves detecting, with the processor, a second input associated with a sleep detection process. Furthermore, the method involves terminating generation of the audio output at a processor when the processor fails to detect the second input.

Detecting the second input may involve a passive sleep detection process. The passive sleep detection process may involve the second input being continuously received at the processor.

Detecting the second input may involve an active sleep detection process. The active sleep detection process may involve the second input being discrete and provided periodically.

The method may further involve storing a value in a pointer on a memory storage unit. The value may be associated with a first time-position of the audiobook.

The method may further involve updating the pointer associated with the first time-position of the audiobook.

The method may further involve resuming the generation of the audio output from a second time-position based on the pointer.

The second time-position may be set to be equal to the first time-position.

The second time-position may be set to be a predetermined period of time before the first time-position.

The predetermined period of time may be calculated based on an elapsed time since terminating the generation of the audio output.

The method may further involve detecting a cancel request with the processor. The cancel request may be for cancelling the sleep detection request.

The method may further involve initiating a sleep timer process.

Initiating the sleep timer process may involve receiving input corresponding to a sleep time.

In accordance with an aspect of the specification, there is provided a method of controlling an electronic device. The method involves loading a pointer value stored in a memory storage unit into a processor. The pointer value is associated with a first time-position of an audiobook. The method further involves loading the audiobook associated with the pointer from the memory storage unit into the processor. In addition, the method involves setting a second time-position of the audiobook associated with the pointer value. Furthermore, the method involves generating audio output at a processor from the time-position.

The second time-position may be set to be equal to the first time-position associated with the pointer value.

The second time-position may be set to be a predetermined period of time before the first time-position associated with the pointer value.

The predetermined period of time may be calculated based on an elapsed time since a prior termination of the audio output.

In accordance with an aspect of the specification, there is provided a non-transitory computer readable medium encoded with codes. The codes are for directing a processor to generate audio output corresponding to an audiobook. Furthermore, the codes are for directing a processor to receive a first input corresponding to a sleep detection request. In addition, the codes are for directing a processor to detect a second input associated with a sleep detection process. The codes are also for directing a processor to terminate generation of the audio output at a processor when the processor fails to detect the second input.

### BRIEF DESCRIPTION OF THE DRAWINGS

Reference will now be made, by way of example, to the accompanying drawings in which:

FIG. 1 is a perspective view of a portable electronic device in accordance with an embodiment;

FIG. 2 is a schematic representation of a portable electronic device in accordance with the embodiment shown in FIG. 1;

FIG. 3 is a perspective view of a portable electronic device in accordance with another embodiment;

FIG. 4 is a flow chart of a method of controlling a portable electronic in accordance with an embodiment;

FIG. 5 is a flow chart of a method of controlling a portable electronic in accordance with another embodiment;

FIG. 6 is a flow chart of a method of controlling a portable electronic in accordance with yet another embodiment;

FIG. 7 is a flow chart of a method of controlling a portable electronic in accordance with yet another embodiment; and

FIG. 8 is a flow chart of a method of controlling a portable electronic in accordance with yet another embodiment.

### DETAILED DESCRIPTION

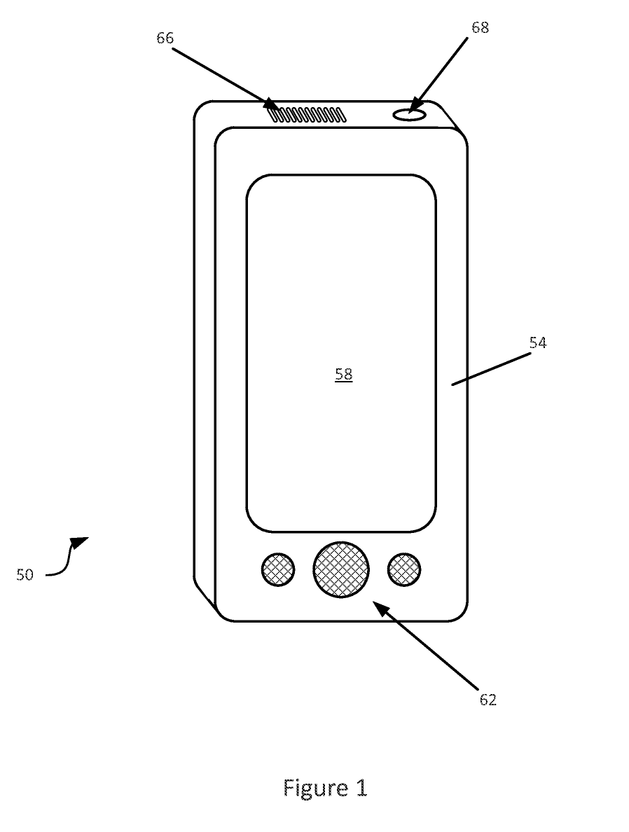

Referring to FIG. 1, a portable electronic device for providing content is generally shown at 50. It is to be understood that the portable electronic device 50 is purely exemplary and with the benefit of this description, it will become apparent to those skilled in the art that a variety of portable electronic devices are contemplated. In the present embodiment, the portable electronic device 50 includes a chassis 54 that supports a display 58, controls 62, speaker 66, and an output interface 68.

In terms of providing physical support, the chassis 54 is mechanically structured to house the internal components of the portable electronic device 50 as discussed below, and support components such as the display 58, the controls 62, and the output interface 68. In the present embodiment, the chassis 54 includes openings near the speaker 66 to facilitate sound output generated by the portable electronic device 50.

It is to be understood that the portable electronic device 50 shown in FIG. 1 is merely an example, and it will be apparent to those skilled in the art that a variety of different portable electronic device structures are contemplated. Indeed, variations of the portable electronic device 50 can include, without limitation, a cellular telephone, a portable email paging device, a camera, a portable music player, a portable video player, a personal digital assistant, a portable book reader, an portable media player, a portable video game player, a tablet computer, a netbook computer, or a laptop computer. Other contemplated variations include devices which may not necessarily be portable, such as desktop computers.

The display 58 can include one or more light emitters such as an array of light emitting diodes (LED), liquid crystals, plasma cells, or organic light emitting diodes (OLED). Alternatively, the display 58 can also include non-emitting screens such as an electrophoretic ink (E ink) screen. It is to be understood that the display is generally configured to provide output from the portable electronic device 50. For example, the display can be configured to output information related to content being provided via the speaker 66 and/or the output interface 68.

The controls 62 are not particularly limited and can include various types of interfaces for receiving input. For example, the controls 62 can include buttons configured to navigate through various menus on the portable electronic device 50. Furthermore, the controls 62 can further be configured control the output of content stored on the portable electronic device 50, such as an audiobook.

The speaker 66 and the output interface 68 are generally configured to provide output associated with content. For example, the speaker 66 is configured to general audio output, such as for an audiobook or other recorded content. Although the present embodiment shows the speaker 66 as a single speaker, it is to be understood with the benefit of this description that the portable electronic device 50 can be modified to include more speakers. The additional speakers can be used to provide stereophonic sound, surround sound, or virtual surround sound. The output interface 68 provides signals corresponding audio output for an external device (not shown), such as headphones or speakers. In the present embodiment, the output interface 68 is a 3.5 mm connector. In other embodiments, the output interface can be modified to be any type of interface capable of transmitting audio output to the external device. For example, other embodiments can include a wireless interface such to provide a Bluetooth connection.

In general terms, the portable electronic device 50 is configured to receive content and render output associated with the content. It is to be re-emphasized that the structure shown in FIG. 1 is a non-limiting representation only and that several variations and modifications are contemplated. For example, it is to be understood with the benefit of this description that some components shown in FIG. 1 are optional and can be omitted in some embodiments as will be discussed in greater detail below.

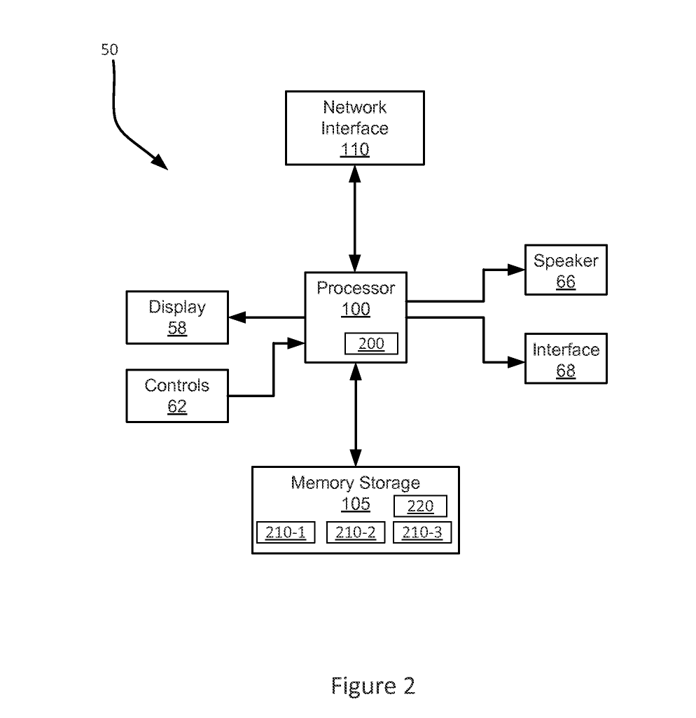

Referring to FIG. 2, a schematic block diagram of the electronic components of the portable electronic device 50 is shown. It is emphasized that the structure in FIG. 2 is purely exemplary. In the present embodiment, the portable electronic device 50 is configured to receive content, store the content, and render output associated with the content. In particular, the portable electronic device 50 includes a processor 100, a memory storage unit 105, and a network interface 110. The processor 100 is in electrical communication with the display 58, the speaker 66, the output interface 68, the memory storage unit 105, and the network interface 110.

The processor 100 is generally configured to execute programming instructions 200. In the present embodiment, the programming instructions 200 can be stored on any type of computer readable medium accessible by the processor 100. The programming instructions 200 are generally configured to direct the processor 100 to receive content via the network interface 110, for example, in the form of a data file from a content server (not shown) and generate output associated with the content. In the present embodiment, each data file can be an audio file encoded with digital audio output, such as a MP3, WAV, WMA, OGG, or M4B (M4A/MP4) corresponding to an audiobook 210-1, 210-2, and 210-3. Although the present embodiment shows the content is an audiobook, it is re-emphasized that the above embodiment is a non-limiting example. In other embodiments, the content can include music, movies, or television shows. In further embodiments, the content can include text or images corresponding to an audiobook which are to be outputted on the display 58 in combination with the audio output, or as an alternative to the audio output.

The programming instructions 200 are generally further configured to direct the processor 100 to process the content to render output on at least one of the display 58, the speaker 66, and the output interface 68. In the present embodiment, the content is an audio file having a standard format, for example one of the formats discussed above, capable of being processed by the processor 100 in accordance with the programming instructions 200. In other embodiments, the content can be a stored in a file having a proprietary format configured to be processed by the programming instructions 200 of an application running on the portable electronic device 50. It is to be understood, with the benefit of this description, that the programming instructions 200 further include code for carrying out various operations such as using pointers for bookmarking the audiobooks 210-1, 210-2, and 210-3 and controlling the state of the portable electronic device 50.

The memory storage unit 105 can be of any type such as non-volatile memory (e.g. Electrically Erasable Programmable Read Only Memory (EEPROM), Flash Memory, hard disk, floppy disk, optical disk, solid state drive, or tape drive) or volatile memory (e.g. random access memory (RAM)). Although the memory storage unit 105 is generally a type of non-volatile memory because of the robust nature of non-volatile memory, some embodiments can use volatile memory in situations where high speed access is desired. In the present embodiment, the memory storage unit 105 is a non-volatile memory unit storing a plurality of audiobooks 210-1, 210-2, and 210-3 and at least one pointer 220.

The network interface 110 is not particularly limited and can include various network interface devices such as a network interface controller (NIC). The network interface 110 is generally configured to connect the portable electronic device 50 to a network for downloading content. For example, the network interface 110 can connect to a network using a data link layer standard such as Ethernet, Wi-Fi, mobile network (for example, fourth generation (4G), third generation (3G), code division multiple access (CDMA), Groupe Special Mobile (GSM) or Long Term Evolution (LTE) standards), or Token Ring. In the present embodiment, the network interface 110 is generally configured to provide the processor with access to content such as the plurality of audiobooks 210-1, 210-2, and 210-3 for download to the portable electronic device 50 from a content server.

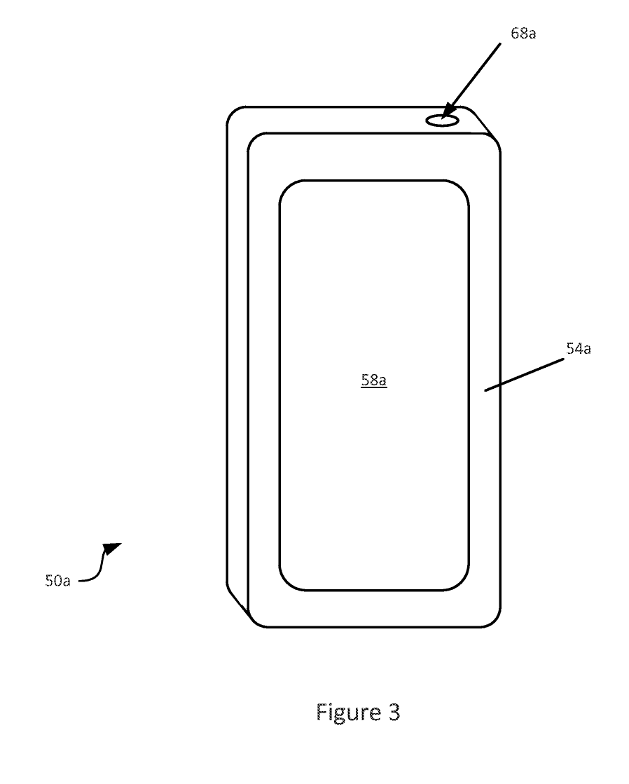

Referring now to FIG. 3, another embodiment of a portable electronic device for providing content is generally shown at 50a. Like components of the portable electronic device 50a bear like reference to their counterparts in the portable electronic device 50, except followed by the suffix “a”. For example, the portable electronic device 50a includes a chassis 54a that supports a touchscreen display 58a and an output interface 68a.

In terms of providing physical support, the chassis 54a is mechanically structured to house the internal components and can include similar materials and design as the chassis 54. It is to be appreciated, with the benefit of this description, that since the portable electronic device 50a differs from the portable electronic device 50 by not including controls 62 and the speaker 66, the chassis 54a can include a simpler design that does not accommodate these features.

The touchscreen display 58a can include one or more light emitters such as an array of light emitting diodes (LED), liquid crystals, plasma cells, or organic light emitting diodes (OLED). Alternatively, the display can also include non-emitting screens such as an electrophoretic ink (E ink) screen. Furthermore, it is to be understood that the touchscreen display 58a includes a mechanism for receiving touch input such as a capacitive or resistive touchscreen. It is to be understood that the display is generally configured to provide output from the portable electronic device 50a and to receive input simultaneously. For example, the touchscreen display 58a can be configured to output information related to content being provided via the output interface 68a and to receive input for controlling the portable electronic device 50a. The input received at the touchscreen display 58a is not limited and can include input that would have otherwise been received via the controls 62 in the portable electronic device 50. In particular, the touchscreen display 58a can be configured to control the portable electronic device 50a by being configured to navigate through various menus on the portable electronic device 50a control the output of content stored on the portable electronic device 50a, such as an audiobook.

The output interface 68a is generally configured to provide output associated with content. The output interface 68a can provides signals corresponding audio output for an external device (not shown), such as headphones or speakers. In the present embodiment, the output interface 68 is a 3.5 mm connector. In other embodiments, the output interface can be modified to be any type of interface capable of transmitting audio output to the external device. For example, other embodiments can include a wireless interface such to provide a Bluetooth connection.

In general terms, the portable electronic device 50a is configured to store and/or receive content and render output associated with the content. It is to be re-emphasized that the structure shown in FIG. 2 is another non-limiting representation only and that further variations and modifications are contemplated.

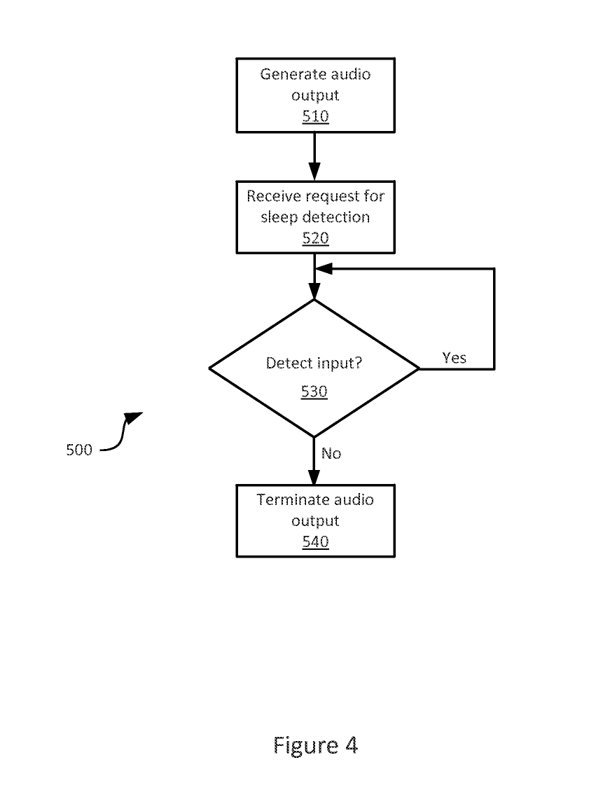

Referring now to FIG. 4, a method of controlling a portable electronic device 50 of 50a is represented in the form of a flow-chart and indicated generally at 500. In order to assist in the explanation of the method 500, it will be assumed that the method 500 is performed by the processor 100 of the portable electronic device 50 as directed by the programming instructions 200. Furthermore, the following discussion of the method 500 will lead to further understanding of the portable electronic device 50 and its various components. It is to be understood that the portable electronic device 50 and/or the method 500 can be varied, and need not work exactly as discussed herein in conjunction with each other, and that such variations are within the scope of the present invention. For example, it is to be appreciated that the method 500 can be carried out on the portable electronic device 50a as well. Furthermore, it is to be emphasized, that method 500 need not be performed in the exact sequence as shown and that various blocks can be performed in parallel rather than in sequence; hence the elements of the method 500 are referred to herein as “blocks” rather than “steps”.

Block 510 comprises generating audio output at the processor 100 associated with content stored in the memory storage unit 105. The manner by which audio output is generated is not particularly limited and can include various methods. In the present embodiment, the processor 100 can convert one of the plurality of audiobooks 210-1, 210-2, and 210-3 stored as an audio file on the memory storage unit 105 into audio output for the speaker 66 or the output interface 68. In another embodiment, it is appreciated that block 510 can be modified such that the processor 100 is directed to receive a stream of data via the network interface 110. The stream of data can correspond to a portion of content to be rendered by the processor 100 for output to the speaker 66 or the output interface 68. In yet another embodiment, the processor 100 can be directed to convert one of the audiobooks 210-1, 210-2, or 210-3 stored as a text file on the memory storage unit 105 into audio output using text to speech technology.

Furthermore, it is to be appreciated, with the benefit of this description, that block 510 is generally continuously being performed by the processor 100. The continuous performance of block 510 is corresponds to the portable electronic device 50 generating audio output for consumption. Accordingly, block 510 can be an example a block running in parallel with the blocks below.

Block 520 comprises receiving a request for sleep detection at the processor 100 of the portable electronic device 50. In the present embodiment, the request originates from the controls 62 receiving an input corresponding to the request for sleep detection. The manner by which the request for sleep detection is received is not particularly limited. For example, the controls 62 can include a dedicated button or other input mechanism corresponding to the request for sleep detection. Alternatively, the controls 62 can be used to navigate through one or more menus rendered on the display 58 to make a selection to request sleep detection. The input received at the controls 62 is transmitted as a signal to the processor 100 and the programming instructions 200 direct the processor 100 to recognize the request for sleep detection and to implement a sleep detection process. Although the present embodiment receives input corresponding to a request for sleep detection via the controls 62, it is to be appreciated, with the benefit of this description, that the request for sleep detection can be received via other input devices. For example, in some embodiments, the display 58 can modified to include a touchscreen input such as the touchscreen display 58a described in connection with the portable electronic device 50a. Accordingly, for the portable electronic device 50a, the request for sleep detection can be received via the touchscreen display 58a as one possible alternative to the controls 62.

Block 530 comprises the processor 100 detecting a predetermined input as part of the sleep detection process. In the present embodiment, the predetermined input is to be continuously detected by the processor 100. The manner by which the predetermined input is detected or from where the input originates is not particularly limited and a person of skill in the art would recognize that a wide variety of inputs can be used in connection with block 530. For example, in the present embodiment, the sleep detection process includes detecting a continuous input from the controls 62, such as from the actuation of a button or other input mechanism. The predetermined input from the controls 62 can be the same input as used for the request for sleep detection at block 520. Alternatively, a separate button can be used for the predetermined input. In the present embodiment, if the predetermined input continues to be detected, the processor 100 loops back to block 530 indefinitely. Alternatively, if the predetermined input is no longer detected, the method 500 advances to block 540. It is to be appreciated that the speed of detection at block 530 is limited by the speed of the processor 100 and other hardware associated with carrying out block 530. In general, block 530 represents a passive sleep detection process where a predetermined input is to be continuously received. For example, the constant input can represent a user depressing a button of the controls 62 in order to maintain the operation of block 510 in parallel. It is to be appreciated that while receiving the predetermined input, it can be assumed that the user is awake and when the predetermined input is no longer detected, it can be assumed that the user has fallen asleep. For example, if the user has fallen asleep, the user will relax and no longer be able to depress a button of the controls 62 to provide the continuous predetermined input.

It is to be re-emphasized that the method 500 is a non-limiting example. For example, although the present embodiment uses the controls 62 for receiving a continuous predetermined input, it is to be appreciated, with the benefit of this description, that the predetermined input can be received via other input devices. As an example, in some embodiments, the display 58 can modified to include a touchscreen input such as the touchscreen display 58a described in connection with the portable electronic device 50a. Accordingly, the predetermined input can be continuously received via the touchscreen display 58a as an alternative to the controls 62. Further variations of the portable electronic device 50 are contemplated to provide other predetermined inputs, such as from an accelerometer detecting orientation or motion of the portable electronic device, a camera or a photosensor for detecting ambient light, or a microphone for detecting sound. In addition, the portable electronic device 50 can be modified to allow for other forms of input from external devices such as a breathing monitor, heart rate monitor, or an electroencephalogram (EEG) monitor. In other embodiments, the programming instructions 200 can include instructions for the processor 100 to analyze images from a camera (not shown) or other input from the portable electronic device 50 to determine the state of the user, such as performing an eye-detection operation to determine if the user's eyes are opened or closed or to determine whether the user's attention is directed to the personal electronic device 50 by detecting eye contact.

Furthermore, it is to be re-emphasized that the blocks of the method 500 need not be performed consecutively immediately after the preceding block and that variations of the method 500 can include additional steps not shown. For example, after receiving the request for sleep detection at block 520, the processor 100 can pause for a predetermined length of time, such as 30 seconds, before proceeding to block 530. It is to be appreciated that the pause is not particularly limited and can be adjustable or fixed to another length of time. Furthermore, during the pause, the processor 100 can be directed to render a timer on the display 58 for counting down the time remaining in the pause. In general, this pause can provide the user with an opportunity to position the portable electronic device 50 after requesting sleep detection in block 520. For example, in general, the portable electronic device 50 can rest in a storage compartment of a bag or clothing such that the user can operate the controls 62 comfortably after sleep detection is requested. For example, in order to operate the controls 62 of the portable electronic device 50 for the purpose of navigating a menu or other general function, the portable electronic device 50 is held generally by a user such that the user can reach each input device of the controls 62 and view the display 58 without having to reposition the portable electronic device 50. Once block 520 has been selected and the sleep detection process begins, the user no longer needs to view the display 58 and the portable electronic device 50 can be repositioned to a location for carrying out the remainder of the method 500. For example, the portable electronic device 50 can be placed in a pocket of a bag while providing access to the controls 62. As another example, the portable electronic device can simply be put down on a table or other surface such that the controls 62 are accessible and the display 58 is not visible to the user.

Block 540 comprises the processor 100 terminating the audio output. The manner by which the audio output is terminated is not particularly limited and a person of skill in the art would recognize that a wide variety of operations can be carried out by the processor 100 to terminate the audio output. For example, the programming instructions 200 can direct the processor 100 to close the program generating the audio output, such as a media player playing an audiobook. Alternatively, the programming instructions 200 can direct the processor 100 to enter a “sleep mode” or “power save” mode where all processes are suspended. As another alternative, the programming instructions 200 can direct the processor 100 to power down the portable electronic device 50 completely. Furthermore, in some embodiments, the termination of the audio output can involve fading the volume of the audio output over a predetermined length of time during which the process of block 540 can be cancelled and the method 500 can returned to block 530. Alternatively, the process of terminating the audio output at block 540 can be fast or instantaneous. It is to be appreciated, with the benefit of the description, that the termination of the audio output at block 540 is configured to execute when with a user falls asleep or is no longer paying attention to the audio output as determined at block 530.

Again, it is to be re-emphasized that the method 500 described above is a non-limiting representation and that variations are contemplated. For example, the method 500 can be combined with a sleep timer process such that the audio output would be terminated either after a predetermined time determined by the sleep timer or as a results of the performance of the method 500. In the present embodiment, the sleep timer process can be initiated by input received from the controls 62 corresponding to a menu selection. Alternatively, the sleep timer process can be automatically initiated as part of the programming instructions 200. The sleep timer process is not particularly limited and the amount of sleep time can generally be adjusted by input received at the processor 100. Further alternative embodiments can include fixed discrete values for the sleep timer. It is to be appreciated that the audio output can be terminated by the processor 100 as a result of either the method 500 or the sleep timer process, whichever occurs first. Alternatively, it is to be appreciated that the audio output can also be terminated as a result of both the method 500 and the sleep timer process calling for the termination of the audio output.

As another example of a variation, the processor 100 can be further directed to detect a cancel request during the operation of any one of blocks 520, 530, and 540 for returning the method 500 to block 510. It is to be appreciated, with the benefit of this description, that the cancel request effectively cancels the request for sleep detection such that the method 500 returns to block 510 and the processor 100 continues to generate audio output corresponding to the content. The manner by which the cancel request is received is not particularly limited and can be received via the controls 62. Alternatively, the cancel request can also be received via other input devices. For example, in some embodiments, the display 58 can modified to be a touchscreen display 58a for receiving the cancel request. Further variations are contemplated such as input from an accelerometer detecting motion of the portable electronic device 50 as well as other methods discussed above for determining the state of the user.

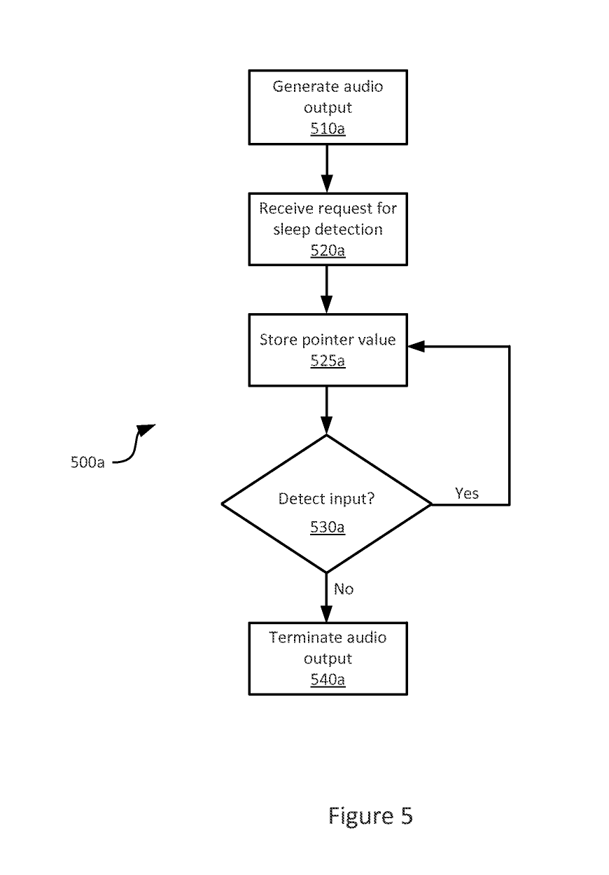

Referring now to FIG. 5, a method in accordance with another variation controlling the portable electronic device 50 or 50a is represented in the form of a flow-chart and indicated generally at 500a. Like blocks of the method 500a bear like reference to their counterparts in the method 500, except followed by the suffix “a”. Similar to the method 500, in order to assist in the explanation of the method 500a, it will be assumed that method 500a is performed using portable electronic device 50. Furthermore, the following discussion of method 500a will lead to further understanding of portable electronic device 50 and its various components as well as variations of the methods that can be carried out on the portable electronic device 50.

Block 510a comprises generating audio output at the processor 100. The manner by which audio output is generated is not particularly limited and can include various methods including those described above in connection with block 510.

Next, block 520a comprises receiving a request for sleep detection at the processor 100 of the portable electronic device 50. Similar to the method described in association with block 520, the request originates from the controls 62 receiving an input corresponding to the request for sleep detection in the present embodiment. The manner by which the request for sleep detection is received is not particularly limited and can include various alternative methods discussed above in connection with block 520.

Block 525a comprises the programming instructions 200 directing the processor 100 to store a value in the pointer 220. The value stored in the pointer 220 is generally associated with a time-position of the content at the moment when block 525a is carried out. For example, in the present embodiment where the content is an audiobook, the pointer 220 can represent a time-position within the audiobook and used to bookmark a location in the audiobook. Block 510a is generally being performed at the same time in parallel with the other blocks. Therefore, the value stored in the pointer 220 changes each time block 525a is executed since the audio output generated in accordance to block 510a advances the time position.

The manner by which value is stored in the pointer 220 is not particularly limited and can include several variations. For example, the pointer 220 can inherently include a content identifier associated with the specific content generating the audio output. For example, it is to be appreciated that in embodiments where the portable electronic device 50 is configured to generate audio output from a plurality of content, such as multiple audiobooks 210-1, 210-2, and 210-3, the content identifier can identify the specific audiobook 210-1, 210-2, or 210-3 associated with the audio output generated at block 510a. In particular, the content identifier can include an International Standard Book Number, Title, or other means of identifying the audiobook 210-1, 210-2, or 210-3. It is to be appreciated that the content identifier is optional for embodiments where the portable electronic device 50 includes a single audiobook or for embodiments where information correlating with the audiobook 210-1, 210-2, or 210-3 to a pointer is stored separately, such as in an external file having a table associating a specific pointer with an audiobook.

Block 530a comprises the processor 100 detecting a predetermined input as part of the sleep detection process. The manner by which the predetermined input is detected or from where the input originates is not particularly limited and can include various methods including those described above in connection with block 530. In the present embodiment, if the predetermined input continues to be detected, the processor 100 returns to block 525a to update the pointer 220 by overwriting any previous value stored the pointer 220. It is to be appreciated, with the benefit of the description, that returning to block 525a effectively updates the pointer 220 since block 510a continues to generate audio output in parallel to the operation of blocks 525a and 530a. Alternatively, if the predetermined input is no longer detected, the method 500a advances to block 540a. In the present embodiment, the pointer 220 is maintained in the memory storage unit 105. In other embodiments, the pointer 220 can be modified such that it is not stored on the memory storage unit 105. For example, the pointer 220 can be stored on another computer readable medium in the portable electronic device 50, on an external server connected to a network, or a combination of both.

In the present embodiment, after storing the value in the pointer 220 at block 525a, the processor 100 can optionally pause for a predetermined length of time, such as 30 seconds, before proceeding to block 530a. It is to be appreciated that the pause is not particularly limited and can be adjustable or fixed to another length of time. Alternatively, there can be no pause between block 525a and block 530a such that the blocks are carried out as fast as possible by the processor 100. In general, the pause between block 525a and block 530a can be associated with the frequency by which the pointer 220 is updated by overwriting any previous value stored from a prior operation of block 525a. It is to be understood that more frequent updating of the pointer 220 results in a more accurate record of the time-position of the content at which the audio output terminates. It is to be appreciated, with the benefit of this description, that this increase in accuracy also results in an increased demand on the resources of the processor 100.

Block 540a comprises the processor 100 terminating the audio output. The manner by which the audio output is terminated is not particularly limited and can include various methods including those described above in connection with block 540.

Again, it is to be re-emphasized that the method 500a described above is a non-limiting representation and that variations are contemplated. With the benefit of the present description, it is to be appreciated that the method 500a is a variation of the method 500. In particular, the method 500a effectively adds an automatic bookmarking function to the method 500 such that when audio output is terminated by block 540a, the pointer 220 will store a value corresponding to the time-position of the content at the approximate location when the audio output is terminated. It is to be understood that this value can be used to represent a time-position in the audiobook where the user has fallen asleep or stopped paying attention to the content. The pointer 220 can then be subsequently used to resume playback of the audiobook at a later time at a time-position associated with the time-position where the pointer 220, as discussed in greater detail below.

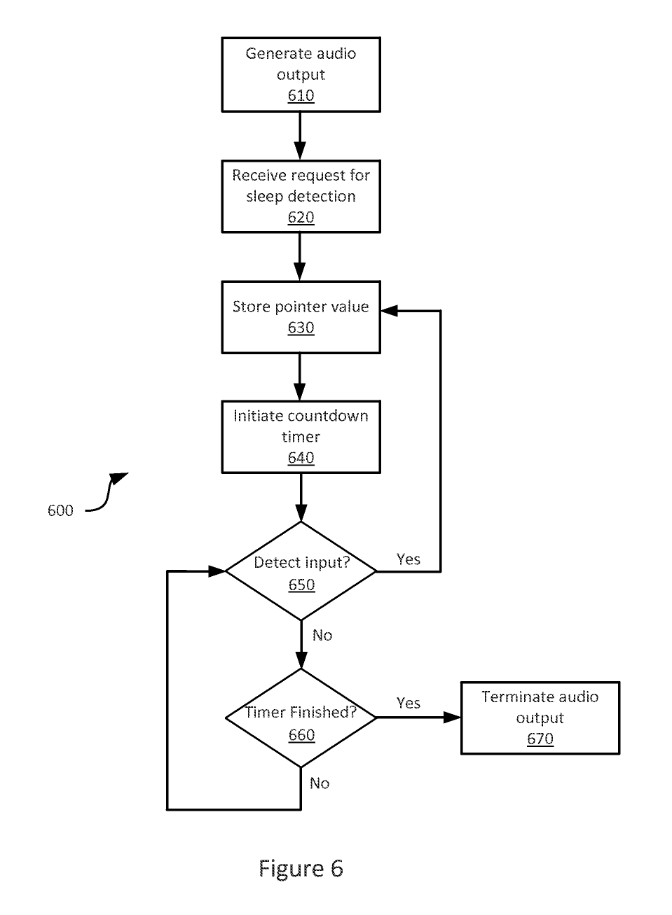

Referring now to FIG. 6, a method of controlling a portable electronic device 50 or 50a in accordance with another embodiment is represented in the form of a flow-chart and indicated generally at 600. In order to assist in the explanation of the method 600, it will be assumed that the method 600 is performed by the processor 100 of the portable electronic device 50 as directed by the programming instructions 200. Furthermore, the following discussion of the method 600 will lead to further understanding of the portable electronic device 50 and its various components as well as the versatility of the portable electronic device 50 including the different methods that can be carried out. It is to be understood that the portable electronic device 50 and/or the method 600 can be further varied, and need not work exactly as discussed herein in conjunction with each other, and that such variations are within the scope of the present invention. For example, it is to be appreciated that the method 600 can be carried out on the portable electronic device 50a as well. Furthermore, it is to be emphasized, that method 600 need not be performed in the exact sequence as shown and that various blocks can be performed in parallel rather than in sequence; hence the elements of the method 600 are referred to herein as “blocks” rather than “steps”.

Block 610 comprises generating audio output at the processor 100 associated with content stored in the memory storage unit 105. The manner by which audio output is generated is not particularly limited and can include various methods. In the present embodiment, the processor 100 can convert one of the plurality of audiobooks 210-1, 210-2, and 210-3 stored as an audio file on the memory storage unit 105 into audio output for the speaker 66 or the output interface 68. In another embodiment, it is appreciated that block 610 can be modified such that the processor 100 is directed to receive a stream of data via the network interface 110. The stream of data can correspond to a portion of content to be rendered by the processor 100 for output to the speaker 66 or the output interface 68. In yet another embodiment, the processor 100 can be directed to convert one of the audiobooks 210-1, 210-2, or 210-3 stored as a text file on the memory storage unit 105 into audio output using text to speech technology.

Block 620 comprises receiving a request for sleep detection at the processor 100 of the portable electronic device 50. In the present embodiment, the request originates from the controls 62 receiving an input corresponding to the request for sleep detection. The manner by which the request for sleep detection is received is not particularly limited. For example, the controls 62 can include a dedicated button or other input mechanism corresponding to the request for sleep detection. Alternatively, the controls 62 can be used to navigate through one or more menus rendered on the display 58 to make a selection to request sleep detection. The input received at the controls 62 is transmitted as a signal to the processor 100 and the programming instructions 200 direct the processor 100 to recognize the request for sleep detection and to implement a sleep detection process. Although the present embodiment receives input corresponding to a request for sleep detection via the controls 62, it is to be appreciated, with the benefit of this description, that the request for sleep detection can be received via other input devices. For example, in some embodiments, the display 58 can modified to include a touchscreen input such as the touchscreen display 58a described in connection with the portable electronic device 50a. Accordingly, for the portable electronic device 50a, the request for sleep detection can be received via the touchscreen display 58a as an alternative to the controls 62.

Block 630 comprises the programming instructions 200 directing the processor 100 to store a value in the pointer 220. The value stored in the pointer 220 is generally associated with a time-position of the content at the moment when block 630 is carried out. For example, in the present embodiment where the content is an audiobook, the pointer 220 can represent a time-position within the audiobook and used to bookmark a location in the audiobook. Block 610 is generally being performed at the same time in parallel with the other blocks. Therefore, the value stored in the pointer 220 changes each time block 630 is executed since the audio output generated in accordance to block 610 advances the time position.

The manner by which the value is stored in the pointer 220 is not particularly limited and can include several variations. For example, the pointer 220 can inherently include a content identifier associated with the specific content generating the audio output. For example, it is to be appreciated that in embodiments where the portable electronic device 50 is configured to generate audio output from a plurality of content, such as multiple audiobooks 210-1, 210-2, and 210-3, the content identifier can identify the specific audiobook 210-1, 210-2, or 210-3 associated with the audio output generated at block 610. In particular, the content identifier can include an International Standard Book Number, Title, or other means of identifying the audiobook 210-1, 210-2, or 210-3. It is to be appreciated that the content identifier is optional when the portable electronic device 50 includes a single audiobook stored on the memory storage unit 105 or for other embodiments where information correlating the audiobook 210-1, 210-2, or 210-3 to a pointer is stored separately, such as in an external file having a table associating the pointer 220 with one of the audiobooks 210-1, 210-2, or 210-3.

Block 640 comprises the processor 100 initiating a countdown timer. The manner by which the countdown timer is initiated and operated is not particularly limited and a person of skill in the art would recognize that a wide variety of processes to measure time can be used in connection with block 630. In the present embodiment, the countdown timer is generally configured to measure a the amount of time remaining from an initial predetermined amount of time. It is to be appreciated, with the benefit of this description, that the amount of time remaining can be optionally outputted to the display 58 in some embodiments. The initial predetermined amount of time is not particularly limited and can be a fixed amount of time such as one minute, five minutes, or any other amount of time. Furthermore, in some embodiments, the predetermined amount of time may not be fixed and can be varied by the processor 100 in response to input received from the controls 62 or another input device.

In general, the countdown timer provides a pause after storing the value in the pointer 220 at block 630. As mentioned above, the countdown timer is not particularly limited and can be varied. For example, although the present embodiment uses a countdown timer, it is to be understood that in other embodiments, this can be varied to be an ascending timer to measure time. In further embodiments, the countdown timer can be substituted with a process for calculating time using an internal clock of the portable electronic device 50.

Block 650 comprises the processor 100 detecting a predetermined input as part of the sleep detection process. The manner by which the predetermined input is detected or from where the input originates is not particularly limited and a person of skill in the art would recognize that a wide variety of inputs can be used in connection with block 650. For example, in the present embodiment, the sleep detection process includes detecting discrete additional input from the controls 62, such as from the actuation of a button or other input mechanism. The predetermined input from the controls 62 can be the same input as used for the request for sleep detection at block 620. Alternatively, a separate button can be used for the predetermined input. In the present embodiment, if the predetermined input is detected, the processor 100 returns to block 630 to overwrite any previous value stored the pointer 220 with an updated value. It is to be appreciated that the time used to carry out intermediate blocks allows the time-position of the content generating the audio output at block 610 has advanced. Therefore, when the predetermined input is detected at block 630, the time-position stored in the pointer 220 is effectively updated. In the present embodiment, if no predetermined input is detected, the method 600 advances to block 660.

Block 660 comprises the processor 100 determining whether the countdown timer initiated at block 640 has finished. In general, the countdown timer would be considered to be finished if it reaches a value of zero. The exact determination of whether the countdown timer is finished is not particularly limited and can involve a value other than zero. As mentioned above, the countdown timer is not particularly limited and variations were provided. It is to be understood with the benefit of this description that the operation of block 660 can be modified to determine generally whether the initial predetermine amount of time has elapsed. In the present embodiment, if the countdown timer is not finished, the processor 100 returns to block 650. Alternatively, if the countdown timer is finished, the processor 100 advances to block 670.

In the event that the countdown timer has not finished, it is to be appreciated that the time used carry out the operations of block 660 and return to block 650 allows the time-position of the content generating the audio output at block 610 to advance at the same time the countdown timer to decreases. Furthermore, it is to be re-emphasized that the blocks of the method 600 need not be performed consecutively immediately after the preceding block and that variations of the method 600 can include additional steps not shown. For example, after detecting the predetermined input as part of the sleep detection process at block 650, the processor 100 can pause for a predetermined length of time, such as 30 seconds, before proceeding to block 660. It is to be appreciated that the pause is not particularly limited and can be adjustable or fixed to another length of time to reduce the frequency of running blocks 650 and 660. In general, it is to be understood that more frequent operation of blocks 650 and 660 can result in faster detection of whether the pointer is to be reset or that the method is to be advanced to block 670. It is to be appreciated, with the benefit of this description, that the increase in detection speed generally results in an increased demand on the resources of the processor 100 as more operations would need to be carried out.

Block 670 comprises the processor 100 terminating the audio output. The manner by which the audio output is terminated is not particularly limited and a person of skill in the art would recognize that a wide variety of operations can be carried out by the processor 100 to terminate the audio output. For example, the programming instructions 200 can direct the processor 100 to close the program generating the audio output, such as a media player playing an audiobook. Alternatively, the programming instructions 200 can direct the processor 100 to enter a “sleep mode” or “power save” mode where all processes are suspended. As another alternative, the programming instructions 200 can direct the processor 100 to power down the portable electronic device 50 completely. Furthermore, in some embodiments, the termination of the audio output can involve fading the volume of the audio output over a predetermined length of time during which the process of block 670 can be cancelled and the method 600 can returned to block 630. Alternatively, the process of terminating the audio output at block 670 can be fast or instantaneous. It is to be appreciated, with the benefit of the description, that the termination of the audio output at block 670 is configured to execute when a user falls asleep or no longer paying attention to the audio output as determined from the operations of block 650 and 660.

In general, the method 600 involves an active sleep detection process carried out requiring the portable electronic device 50 to receive an input within a predetermine period of time determined by the countdown timer in the present embodiment. It is to be appreciated, with the benefit of the description, that the difference between a passive sleep detection process and an active sleep detection process is that in the case of the former, the input is expected to be continuous whereas the active sleep detection process expects to receive a plurality of discrete inputs periodically to indicate that the user is awake.

Again, it is to be re-emphasized that the method 600 described above is a non-limiting representation and that variations are contemplated. For example, a variation of the method 600 can include omitting block 630. It is to be appreciated that by omitting block 630, no pointer will be involved and the time-position of the content near which block 670 is carried out is not stored. Accordingly, this variation would not provide any bookmarking of the content. As another example of a variation, the processor 100 can be further directed to detect a cancel request during the operation of during any point while the method 600 is being carried out. The manner by which the cancel request is received is not particularly limited and can be received via the controls 62. Alternatively, the cancel request can also be received via other input devices. For example, in some embodiments, the display 58 can modified to be the touchscreen display 58a for receiving the cancel request. Further variations are contemplated to cancel the method 600 such as input from an accelerometer detecting motion of the portable electronic device 50 as well as other methods discussed above for determining the state of the user.

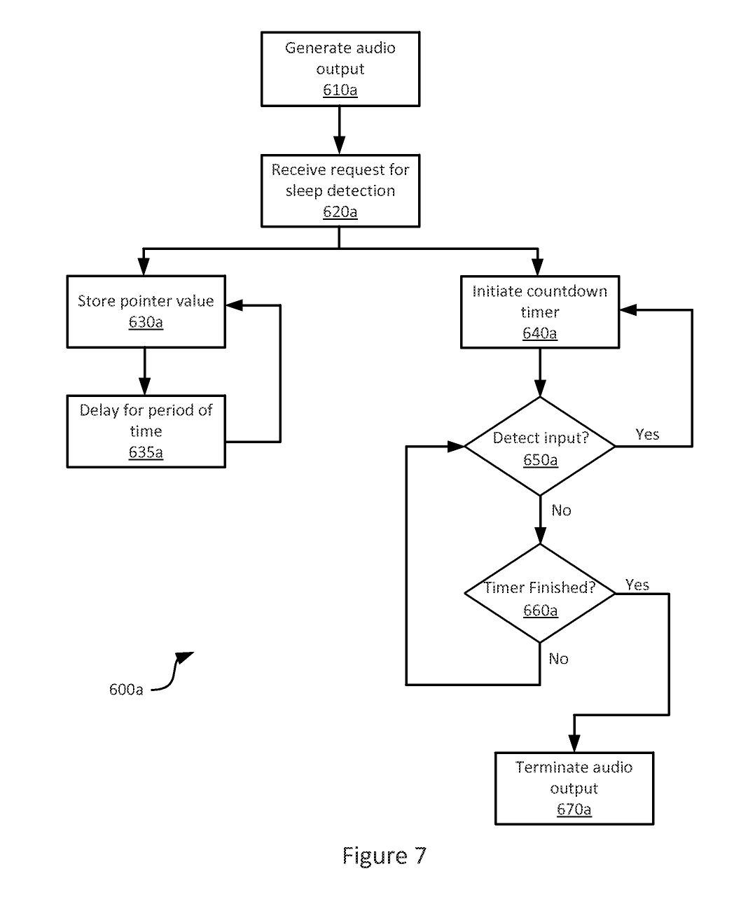

Referring now to FIG. 7, a method in accordance with another variation of the method 600 of controlling the portable electronic device 50 or 50a is represented in the form of a flow-chart and indicated generally at 600a. Like blocks of the method 600a bear like reference to their counterparts in the method 600, except followed by the suffix “a”. Similar to the method 600, in order to assist in the explanation of the method 600a, it will be assumed that method 600a is performed using portable electronic device 50. Furthermore, the following discussion of method 600a will lead to further understanding of portable electronic device 50 and its various components as well as variations of the methods that can be carried out on the portable electronic device 50.

Block 610a comprises generating audio output at the processor 100. The manner by which audio output is generated is not particularly limited and can include various methods including those described above in connection with block 610.

Next, block 620a comprises receiving a request for sleep detection at the processor 100 of the portable electronic device 50. Similar to the method described in association with block 520, the request originates from the controls 62 receiving an input corresponding to the request for sleep detection in the present embodiment. The manner by which the request for sleep detection is received is not particularly limited and can include various alternative methods discussed above in connection with block 620. Once a request for sleep detection is received at the processor 100, the method 600a simultaneously advances to blocks 630a and 640a and blocks 630a and 640a are carried out in parallel as shown in FIG. 7.

Block 630a comprises the programming instructions 200 directing the processor 100 to store a value in the pointer 220 and can include various methods including those described above in connection with block 630.

Block 635a comprises the programming instructions 200 directing the processor 100 to delay for a period of time. For example, the processor 100 can be directed to idle to allow a period of time, such as 30 seconds, one minute or any other length of time to pass. It is to be appreciated that block 635a provides a pause for a specified length of time before returning to block 630a. Accordingly, it is to be understood, with the benefit of this description, that blocks 630a and 635a form an infinite loop whereby the pointer 220 is updated at a fixed rate, such as every 30 seconds, every minute or any other length of time. This loop will continuously update the pointer 220 as long as block 610a is being carried out. The length of the delay at block 635a is not particularly limited and can be set as low as zero which would effectively omit block 635a. The length of delay ultimately controls the frequency at which the pointer 220 is updated. It is to be appreciated that more frequent updating of the pointer 220 results in a more accurate record of the time-position of the content at which the audio output is effectively terminated. In the present example of audiobooks, more frequent updating of the pointer 220 results in a more accurate bookmark. It is to be appreciated that the increase in accuracy of the pointer 220 generally results in an increased demand on the resources of the processor 100.

Operating in parallel with the loop of blocks 630a and 635a described above, block 640a comprises the processor 100 initiating a countdown timer and can include various methods including those described above in connection with block 640.

Block 650a comprises the processor 100 detecting a predetermined input as part of the sleep detection process. The manner by which the predetermined input is detected or from where the input originates is not particularly limited and can include various methods including those described above in connection with block 650. If the predetermined input is detected, the processor 100 returns to block 640a and re-initiates the countdown timer. Alternatively, if no predetermined input is detected, the method 600a advances to block 660a.

Block 660a comprises the processor 100 determining whether the countdown timer initiated at block 640a has finished. Then manner by which the determination is made is not particularly limited and can include various methods including those described above in connection with block 660. In the present embodiment, if the countdown timer is not finished, the processor 100 returns to block 650a. Alternatively, if the countdown timer is finished, the processor 100 advances to block 670a.

Block 670a comprises the processor 100 terminating the audio output and can include various methods including those described above in connection with block 670.

In general, the method 600a is similar to the method of 600 where an active sleep detection process is carried out requiring the portable electronic device to receive an input within a predetermine period of time determined by the countdown timer in the present embodiment. With the benefit of the present description, it is to be appreciated that the method 600a is a variation of the method 600. In particular, the method 600a effectively updates the pointer 220 at regular intervals whereas the method 600 updates the pointer when the predetermined input is received.

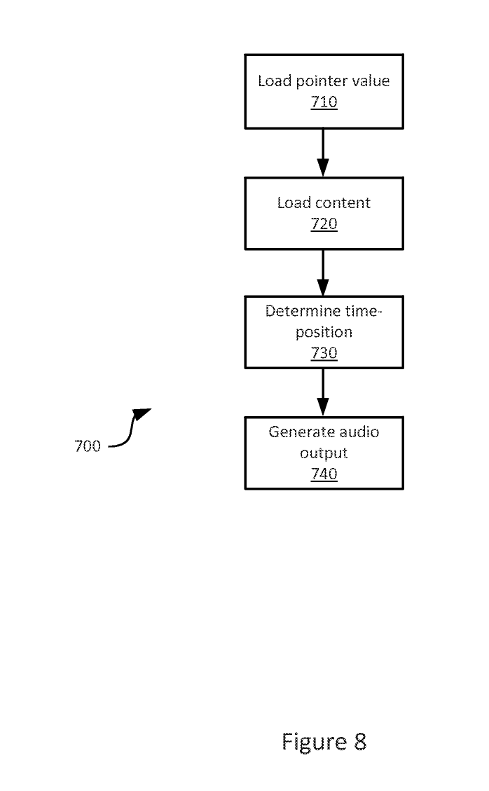

Referring now to FIG. 8, a method of controlling the portable electronic device 50 or 50a in accordance with another embodiment is represented in the form of a flow-chart and indicated generally at 700. In order to assist in the explanation of the method 700, it will be assumed that the method 700 is performed by the processor 100 of the portable electronic device 50 as directed by the programming instructions 200. Furthermore, the following discussion of the method 700 will lead to further understanding of the portable electronic device 50 and its various components as well as the versatility of the portable electronic device 50 including the different methods that can be carried out. It is to be understood that the portable electronic device 50 and/or the method 700 can be further varied, and need not work exactly as discussed herein in conjunction with each other, and that such variations are within the scope of the present invention. For example, it is to be appreciated that the method 700 can be carried out on the portable electronic device 50a as well. Furthermore, it is to be emphasized, that method 700 need not be performed in the exact sequence as shown and that various blocks can be performed in parallel rather than in sequence.

Block 710 comprises the processor 100 loading the value stored in the pointer 220. The manner by which the value stored in the pointer 220 is loaded by the processor 100 is not particularly limited and can include various methods. For example, the pointer 220 can be selected via a menu rendered on the display 58 using the controls 62. In the present embodiment, the pointer 220 is associated with a time-position of a specific content from which the audio output is generated, such as one of the audiobooks 210-1, 210-2, or 210-3. It is to be appreciated, with the benefit of this description, that in the present embodiment, the value stored in the pointer 220 can be associated with a time-position within the content and generally represents a bookmark of a time-position where the portable electronic device 50 last played the content. Although the present embodiment shows that the pointer 220 is generally stored on the memory storage unit 105, it is to be appreciated that the pointer 220 is not particularly limited. For example, the pointer 220 can be stored on a separate memory storage unit (not shown). In another example, the pointer 220 can also be stored on a remote server such as a cloud server accessible to at least the portable electronic device 50. Accordingly, the value stored in the pointer 220 can be loaded from any one of a variety of locations or from different devices.

Block 720 comprises the processor 100 loading content from the memory storage unit 105. The manner by which the content is loaded by the processor 100 is not particularly limited and can include various methods. In the present embodiment, the content can be one of the audiobooks 210-1, 210-2, or 210-3. It is to be understood that the content can be identified by the pointer 220 and that block 720 can be automatically carried out after loading the pointer 220. Alternatively, in some embodiments where the pointer 220 does not identify the specific content, the content can be selected from a menu presented on the display 58. Furthermore, it is to be appreciated, with the benefit of this description, that a portion of the content, such as a chapter of an audiobook, can be loaded when the entirety of the content cannot be loaded due to hardware or software limitations. Although the present embodiment shows that the content is stored on the memory storage unit 105 in the form of audiobooks 210-1, 210-2, or 210-3, it is to be appreciated that physical location where the content is stored is not particularly limited. For example, the content can be stored on a remote server such as a cloud server for streaming on at least the portable electronic device 50. Accordingly, the value stored in the pointer 220 can be loaded from any one of a variety of locations or from different devices.

Block 730 comprises the processor 100 setting a time-position from which the generation audio output of the content is to resume. It is to be appreciated that the time-position from which the generation audio output of the content is to resume is associated with the value stored in the pointer 220. The setting of the time-position from which the generation audio output of the content is to resume is not particularly limited and various calculations can be made to determine and set the time-position from which the generation audio output of the content is to resume. In the present embodiment, the programming instructions 200 allow for several possible options for determining the time-position of the content associated with the pointer 220. Therefore, the operation of block 730 can also present a menu on the display 58 requesting input corresponding to one of the options for setting the time-position of the content. It is to be appreciated that other embodiments can provide more options or fewer options for setting the time-position from which the generation audio output of the content is to resume.

One option involves merely taking the value stored in the pointer 220 and setting to the time-position from which the generation audio output of the content is to resume to be equivalent to the value stored in the pointer 220. For example, if the pointer 220 stored a value of a specific time representing a bookmark set either via input from the controls 62, or through an automated process such as one of methods 500a, 600 or 600a, this option sets the time-position from which the generation audio output of the content is to resume to be the exact same time-position of the content when the pointer 220 was set.

Another option involves setting the time-position from which the generation audio output of the content is to resume to be a predetermined period of time before the value stored in the pointer 220. The predetermined period of time is not particularly limited and can be set at a fixed value such as 30 seconds, 1 minute, 5 minutes, or any other length of time that is appropriate. Alternatively, second option can have an adjustable time period that can be set using the controls 62. Accordingly, this option represents a bookmarking function where the portable electronic device would effectively replay a portion of the content. It is to be appreciated, with the benefit of this description, that the portion of the content that is replayed would allow a user to get back into the flow of the content.

A further option involves setting the time-position from which the generation audio output of the content is to resume in accordance with Equation (1). The processor 100 carries out a calculation of Equation (1), where Y represents a calculated period of time before the value stored in the pointer (also called the replay time), X represents the time since the content was last play and a and b are parameters that are predetermined.

$$Y = \frac{{x}^{a}}{b} \qquad ( 1 )$$

It is to be appreciated, with the benefit of this description, that the time since output associated with the content was last provided to a user would affect the optimal amount of replay time to allow a user to get back into the flow of the content. For example, if a long period of time has elapsed since a user has consumed the content, the user may have forgotten more substantial portions of the content. Therefore, more replay time would allow the memory of the user to be refreshed. Alternatively, if a short period of time has elapsed since a user has consumed the content, the memory of the content will be fresh and less replay time would be required.

The manner by which the value of X is calculated is not particularly limited. In the present embodiment, X can be stored in the pointer 220 in the form of a time stamp as to when the pointer 220 was last updated. In other embodiments, X can be calculated by the processor 100 based on a system log of the portable electronic device 50 or the data can elsewhere on the portable electronic device. The manner by which the parameters a and b are determined are not particularly limited. For example, the programming instructions 200 can direct the processor 100 to generate a prompt on the display 58 for input corresponding to the values of a and b. Alternatively, the values of a and b can be included in the programming instructions 200 such that they cannot be varied. In the present embodiment, it was found that an idea range for a is between about 0.400 and about 0.470, with an optimal value of about 0.435. In the present embodiment, it was found that an idea range for b is between about 10 and about 14, with an optimal value of about 12. Accordingly, the processor 100 calculates Y and the sets the time-position from which the generation audio output of the content is to resume to be a time Y before the value stored in the pointer 220.

It is to be appreciated, with the benefit of this description, that the above possible options for determining the predetermined period of time before the value stored in the pointer 220 are non-limiting examples and that several other options for determining the predetermined period of time before the value stored in the pointer 220 are contemplated. In another embodiment, the determination of the predetermined period can be based on calculations and factors such as the time-position of the content compared to another time-position, such as the time-position of a chapter change. For example, if the value stored in the pointer 220 is within a specified time of the beginning of a chapter, such as within one minute or another length of time, the predetermined period of time before the value stored in the pointer 220 can be set such that the time-position from which the generation audio output of the content is to resume is set to coincide with the beginning of the chapter. As another example, the determination of the predetermined period can be dependent on the type of content, such as the genre of an audiobook, or the manner by which the audio output was terminated.

Block 740 comprises generating audio output from the processor 100. The manner by which audio output is generated is not particularly limited and can include various methods including those described above in connection with blocks 510, 510a, 610 and 610a. For example, block 740 can directs the processor 100 to begin generating the audio output at the time-position set at block 730.

In general, the method 700 provides a method of controlling a portable electronic device 50 to resume generation of the audio output corresponding to the content which has been previously partially played. It is to be appreciated, with the benefit of the description, that the method described in the method 700 is not particularly limited and can be carried out independently of any one of the methods 500, 500a, 600 or 600a. Alternatively, the method 700 can be combined with any one of the methods 500a, 600 or 600a using the pointer 220 from any one of the methods 500a, 600 or 600a. In some embodiments, block 740 can be equivalent to any one of blocks 510, 510a, 610, or 610a to provide a continuous loop of the method 700 combined with any one of the methods 500, 500a, 600 or 600a.

It is to be understood that many combinations, variations and subsets of the embodiments and teachings herein are contemplated. As a non-limiting example, the methods 600 and 600a can be modified to omit the pointer 220. As another non-limiting example, any of one of the methods 500a, 600 and 600a can be combined with the method 700 such that the portable electronic device can be configured to automatically update a pointer so that the processor 100 can resume generating audio output from the content at a time-position near where the audio output was terminated.

While specific embodiments have been described and illustrated, such embodiments are considered illustrative only and should not serve to limit the accompanying claims.

What is claimed is:

1. An electronic device comprising:
a network interface for connecting the electronic device to a network;
a memory storage unit for storing data corresponding to an audiobook; and
a processor in electrical communication with the network interface and the memory storage unit, the processor configured to generate audio output corresponding to the audiobook, receive a first input corresponding to a sleep detection request, detect a second input associated with a sleep detection process, and terminate generation of the audio output when the second input fails to be detected.

2. The electronic device of claim 1, wherein the processor is further configured to carry out a passive sleep detection process, the passive sleep detection process involving continuously receiving the second input.

3. The electronic device of claim 1, wherein the processor is further configured to carry out an active sleep detection process, the active sleep detection process involving discretely receiving the second input periodically.

4. The electronic device of claim 1, wherein the processor is further configured to store a value in a pointer associated with a first time-position of the audiobook.

5. A method of controlling an electronic device, the method comprising:
generating audio output at a processor, the audio output corresponding to an audiobook;
receiving, at the processor, a first input corresponding to a sleep detection request;
detecting, with the processor, a second input associated with a sleep detection process; and
terminating generation of the audio output at a processor when the processor fails to detect the second input.

6. The method of claim 5, wherein detecting the second input comprises a passive sleep detection process involving the second input being continuously received at the processor.

7. The method of claim 5, wherein detecting the second input comprises an active sleep detection process involving the second input being discrete and provided periodically.

8. The method of claim 5, further comprising storing a value in a pointer on a memory storage unit, the value associated with a first time-position of the audiobook.

9. The method of claim 8, further comprising updating the pointer associated with the first time-position of the audiobook.

10. The method of claim 8, further comprising resuming the generation of the audio output from a second time-position based on the pointer.

11. The method of claim 10, wherein the second time-position is set to be equal to the first time-position.

12. The method of claim 10, wherein the second time-position is set to be a predetermined period of time before the first time-position.

13. The method of claim 12, wherein the predetermined period of time is calculated based on an elapsed time since terminating the generation of the audio output.

14. The method of claim 5, further comprising detecting a cancel request with the processor, the cancel request for cancelling the sleep detection request.

15. The method of claim 5, further comprising initiating a sleep timer process.

16. The method of claim 15, wherein initiating the sleep timer process comprises receiving input corresponding to a sleep time.

17. A method of controlling an electronic device, the method comprising:
loading a pointer value stored in a memory storage unit into a processor, the pointer value associated with a first time-position of an audiobook;
loading the audiobook associated with the pointer from the memory storage unit into the processor;
setting a second time-position of the audiobook associated with the pointer value; and
generating audio output at a processor from the time-position.

18. The method of claim 17, wherein the second time-position is set to be equal to the first time-position associated with the pointer value.

19. The method of claim 17, wherein the second time-position is set to be a predetermined period of time before the first time-position associated with the pointer value.

20. The method of claim 19, wherein the predetermined period of time is calculated based on an elapsed time since a prior termination of the audio output.

21. A non-transitory computer readable medium encoded with codes, the codes for directing a processor to:
generate audio output corresponding to an audiobook;
receive a first input corresponding to a sleep detection request;
detect a second input associated with a sleep detection process; and
terminate generation of the audio output at a processor when the processor fails to detect the second input.
